(19) United States
(12) Patent Application Publication
(10) Pub. No.: US 2023/0294296 A1
(43) Pub. Date: Sep. 21, 2023

(54) METHOD, SYSTEM, COMPUTER PROGRAM AND COMPUTER PROGRAM PRODUCT FOR CONTROLLING A ROBOTIC GARDEN TOOL

(71) Applicant: Greenworks (Jiangsu) Co., Ltd., Changzhou (CN)

(72) Inventor: Carl WALLMARK, Landvetter (SE)

(73) Assignee: Greenworks (Jiangsu) Co., Ltd., Changzhou (CN)

(21) Appl. No.: 18/324,993

(22) Filed: May 28, 2023

Related U.S. Application Data
(63) Continuation of application No. PCT/CN2021/141570, filed on Dec. 27, 2021.

(30) Foreign Application Priority Data
Dec. 30, 2020 (CN) 202011606822.6
Dec. 30, 2020 (CN) 202023283031.2

(51) Int. Cl. B25J 11/00; G05D 1/02

(52) U.S. Cl. CPC B25J 11/0055; G05D 1/0274; G05D 2201/0208

(57) ABSTRACT

A method performed by a robotic garden system for controlling a robotic garden tool (1). The system comprises the robotic garden tool (1), a control unit, and a database. The method comprises the steps of: A. Retrieving a predetermined route (3) for a working area (4). The predetermined route (3) is based on a travel angle (6). The travel angle (6) is an angle extending from a starting point (7). The working area (4) delimits the travel of the robotic garden tool (1). A route data set comprises a plurality of predetermined routes. Each predetermined route has a travel angle substantially being different from all other travel angles of all other predetermined routes. B. Controlling the robotic garden tool (1) to start from the starting point (7) and move along the retrieved predetermined route (3).

### TECHNICAL FIELD

The present invention relates to a method, system, computer program and computer program product for controlling a robotic garden tool.

### BACKGROUND

Robotic garden tools found on the market are generally known to be used for mowing the lawn or for cleaning the swimming pool, among other garden activities. To keep the robotic garden tool within a certain working area or to bring back the robotic garden tool to a charging station, boundary wires and other type of guide wires in combination with different antennas have been used. There are different types of methods for covering a specific working area, for instance letting the robotic garden tool work on a random basis.

Installing said peripherals of the robotic garden tools, such as boundary wires, guide wires etc. takes a relatively large effort of the user prior initiating the system. These peripherals are furthermore likely to be damaged by external factors at least once during the lifecycle of the system.

Having a method implemented wherein the robotic garden tool randomly moves within the working area will result in the area eventually being covered. However, this approach is not an optimal method with regards to time required nor energy efficiency.

It is therefore desirable to accomplish a method and a system for controlling a robotic garden tool in an improved manner.

### SUMMARY OF INVENTION

An objective of the present invention is thus to accomplish a method and a system for controlling a robotic garden tool in an improved manner.

According to one aspect, the invention concerns a method performed by a robotic garden system for controlling a robotic garden tool. The system comprises the robotic garden tool, a control unit, and a database. The method comprises the step of retrieving, from the database by means of the control unit, a predetermined route for the robotic garden tool. The predetermined route is within a working area. The predetermined route is stored in a route data set in the database. The predetermined route is based on a travel angle. The travel angle is an angle extending from a starting point for the robotic garden tool located within the working area. The working area delimits the travel of the robotic garden tool. The route data set comprises a plurality of predetermined routes. Each predetermined route has a travel angle substantially being different from all other travel angles of all other predetermined routes. The method further comprises the step of controlling by means of the control unit the robotic garden tool to start from the starting point and move along the retrieved predetermined route.

Using different predetermined routes having travel angles being different from all other travel angles of all other predetermined routes, provides a solution which will prevent permanent marks or unnecessary wear on the surface. If the robotic tool is a robotic lawn mower permanent tracks in the lawn will be prevented. Furthermore, different patterns in a lawn can be created if the robotic garden tool is a lawn mower.

The method above may be configured according to different optional embodiments. For example, the method may be preceded by the steps of defining the working area, and storing in the database a plurality of geographical data points defining the working area.

By defining the working area in such a manner, the working area can be defined for every specific installation once and the working area described in geographical data points can be retrieved for every future work session.

According to an embodiment of the invention the method may further comprise the step of controlling the robotic garden tool by means of the control unit to follow the defined and stored working area before conducting any further activities, such that the user can confirm that the stored working area is correct.

By letting the user confirm the stored working area prior activating the robotic garden tool functions as a strong control mechanism counteracting ill defined working areas. This functionality could prevent accidents as well as damages to humans and property.

According to an embodiment of the invention the defining of the working area may comprise defining the boundary of the working area.

The boundary is an essential element of the working area and the definition of this would thus be of great importance.

According to an embodiment of the invention the defining of the boundary step may comprise controlling the robotic garden tool by means of the control unit to follow the boundary of the working area.

To control the robotic garden tool to physically follow the boundary of the working area is a very efficient and secure way of defining the same.

According to an embodiment of the invention the defining step of the working area may comprise defining the boundary of an obstacle of the working area.

An obstacle is an essential element of the working area and the definition of this would thus be of great importance.

According to an embodiment of the invention in the retrieving step of a predetermined route, the predetermined route may be selected based on the criteria of minimising the number of turns of the robotic garden tool within the working area.

By using a method where the predetermined route is selected based on the criteria of minimising the number of turns of the robotic garden tool within the working area, may be a valuable contribution to fully cover the working area, and to do so as swiftly as possible. This will imply that both the environmental impact of using the robotic garden tool and the stress on the mechanics of the robotic garden tool will be decreased.

According to an embodiment of the invention the travel angle may be in the range of 0 to 180° or in the range of 0 to 360°.

Having the possibility to choose between two said intervals will provide both a very efficient and a very flexible path planning.

According to an embodiment of the invention a positioning unit may be in combination with the control unit used for controlling the robotic garden tool to follow the retrieved predetermined route, and/or the positioning unit may be used for providing a plurality of geographical data points so that the working area may be defined.

Using such a positioning unit may provide a very accurate control functionality and a very accurate definition functionality of the working area.

According to an embodiment of the invention the method further comprises to retrieve a signal by the control unit. The signal indicates that the robotic garden tool should move to a predetermined position. Further, the method comprises to store in the database a geographical data point corresponding to the current geographical position of the robotic garden tool, to control the robotic garden tool by means of the control unit to move to the predetermined position, to control the robotic garden tool by means of the control unit to conduct a certain activity at the predetermined position, to control the robotic garden tool by means of the control unit to return to the geographical position corresponding to stored geographical data point after said certain activity at the predetermined position has been completed, and to control the robotic garden tool by means of the control unit to continue to move along the retrieved predetermined route.

Described method provides the possibility for the robotic garden tool to pause its current tasks, in order for another important activity to be conducted, and subsequently to resume its tasks.

According to an embodiment of the invention the controlling step of the robotic garden tool to follow the retrieved predetermined route may comprise for the robotic garden tool by means of the control unit to move along the travel angle in a straight line, turn when reaching the boundary of the working area, move opposite the travel angle in a straight line, turn when reaching the boundary of the working area, move along the travel angle in a straight line, and continue with said steps, such that the robotic garden tool covers the working area lane by lane.

Described method provides the possibility to cover the total working area fully in an even more efficient manner. Furthermore, different patterns in a lawn can even more efficiently be created if the robotic garden tool is a lawn mower.

According to one aspect, the invention concerns a robotic garden system for controlling a robotic garden tool. The system comprises the robotic garden tool, a control unit, and a database. The system is arranged to retrieve, from the database by means of the control unit, a predetermined route for the robotic garden tool. The predetermined route is within a working area. The predetermined route is stored in a route data set in the database. The predetermined route is based on a travel angle. The travel angle is an angle extending from a starting point for the robotic garden tool located within the working area. The working area delimits the travel of the robotic garden tool. The route data set comprises a plurality of predetermined routes, and each predetermined route has a travel angle substantially being different from all other travel angles of all other predetermined routes. Further, the system is arranged to control by means of the control unit the robotic garden tool to start from the starting point and move along the retrieved predetermined route.

Such a system, using different predetermined routes having travel angles being different from all other travel angles of all other predetermined routes, provides a solution which will prevent permanent marks or unnecessary wear on the surface. If the robotic tool is a robotic lawn mower permanent tracks in the lawn will be prevented. Furthermore, different patterns in a lawn can be created if the robotic garden tool is a lawn mower.

According to another aspect a computer program comprises computer readable code means, which when run on a control unit causes the system to perform the corresponding method.

According to another aspect a computer program product comprises a computer readable medium and a computer program. The computer program is stored on the computer readable medium.

The robotic garden tool may be a robotic lawn mower, among others.

The control unit may be located internally or externally of the robotic garden tool. If located externally it could be located at a charging station of the robotic garden tool, among others.

The database may either be located externally outside the robotic garden tool, for instance in a cloud solution among others, or internally in a physical data storage device within the robotic garden tool.

The working area may be a sub area of a larger working area.

A plurality of working areas may overlap each other.

The positioning unit may be a GNSS device, such as a GPS device, an RTK device, among others.

The predetermined position may be the position of a charging station, a station for downloading data, among others.

The certain activity may for instance be an activity focused on charging the batteries of the robotic garden tool, on updating the software of the robotic garden tool, or waiting for a specific manual maintenance of the robotic garden tool to be conducted, among others.

When the robotic garden tool turns and follows the next lane opposite the travel angel the robotic garden tool may either slightly overlap the previous lane or not overlap the previous lane at all. The latter could be accomplished by controlling the robotic garden tool to border the previous lane. Different working widths of different robotic garden tools would have to be considered for calculating the desired outcome.

The travel angel may be determined randomly or according to a predetermined schedule.

Prior the robotic garden tool starts to move along the retrieved predetermined route, information regarding the route, such as travel time among others, could be sent to the owner/user of the robotic garden tool for the owner/user to either accept or decline initiation of the specific predetermined route.

The positioning unit in combination with the control unit may be used for controlling the robotic garden tool to follow the retrieved predetermined route for all described claims, and also for defining the working area for all described claims, for enabling storing in the database the plurality of geographical data points defining the working area.

### BRIEF DESCRIPTION OF DRAWINGS

The invention is now described, by way of example, with reference to the accompanying drawings, in which:

FIG. 1 is a flow chart of a procedure according to an embodiment.

FIG. 2 is a flow chart of a procedure according to an embodiment.

FIG. 3 is a flow chart of a procedure according to an embodiment.

FIG. 4 is a flow chart of a procedure according to an embodiment.

FIG. 5 is a flow chart of a procedure according to an embodiment.

FIG. 6 is a block diagram illustrating a control unit, according to a possible embodiment.

FIG. 7 is a block diagram illustrating a robotic garden system in connection with a user, according to a possible embodiment.

FIG. 8 shows a robotic garden tool in connection with its surroundings in a schematic view, according to an embodiment of the invention, and

FIG. 9 shows a predetermined route in a perspective view, according to an embodiment of the invention, and

FIG. 10 shows a predetermined route in a perspective view, according to an embodiment of the invention, and

FIG. 11 shows a predetermined route in a perspective view, according to an embodiment of the invention, and

FIG. 12 shows a predetermined route in a perspective view, according to an embodiment of the invention.

### DESCRIPTION OF EMBODIMENTS

In the following, a detailed description of a method, system, computer program and computer program product for controlling a robotic garden tool, is provided.

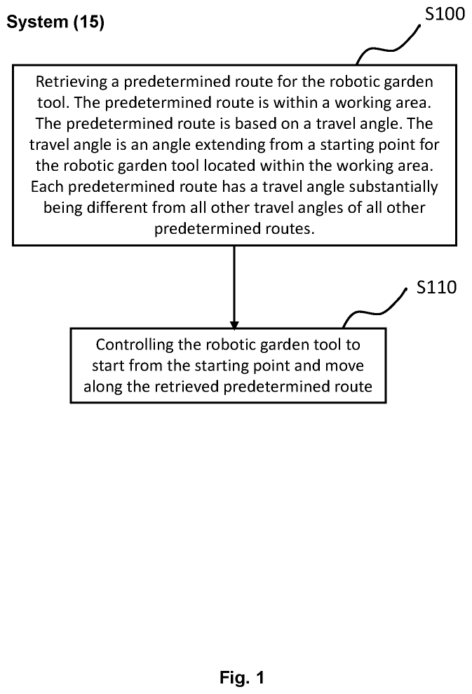

FIG. 1 shows a flow chart illustrating a procedure in a system. The various actions may come in different orders than presented in this description, or in a different order than shown in this or other flowcharts related to this description, or some steps may be performed in parallel.

In a step S100 a predetermined route 3 for the robotic garden tool 1 is retrieved from the database 2 by means of the control unit 13. The predetermined route 3 is within a working area 4. The predetermined route 3 is stored in a route data set 5 in the database 2. The predetermined route 3 is based on a travel angle 6. The travel angle 6 is an angle extending from a starting point 7 for the robotic garden tool 1 located within the working area 4, and the working area 4 delimits the travel of the robotic garden tool 1. The route data set 5 comprises a plurality of predetermined routes 3a . . . n, and each predetermined route 3 has a travel angle 6 substantially being different from all other travel angles of all other predetermined routes. Further the robotic garden tool 1 is controlled by means of the control unit 13 to start from the starting point 7 and move along the retrieved predetermined route 3. In a step S110 the robotic garden tool 1 is controlled by means of the control unit 13 to start from the starting point 7 and to move along the retrieved predetermined route 3.

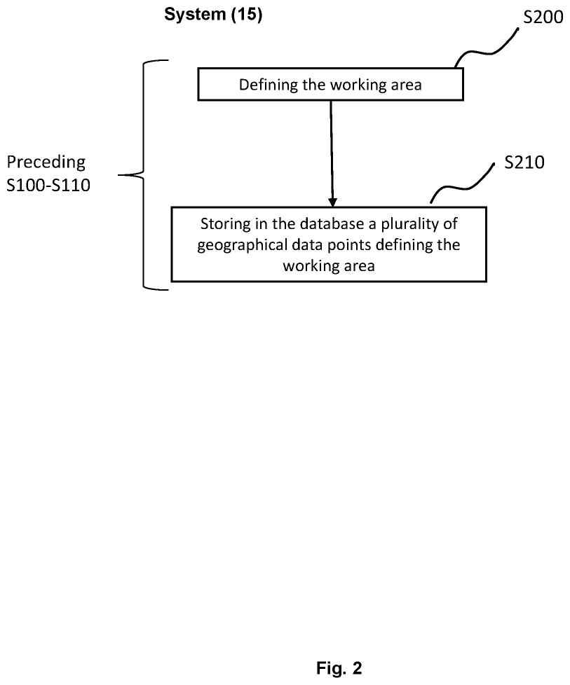

FIG. 2 shows a flow chart illustrating a procedure in a system. The various actions may come in different orders than presented in this description, or in a different order than shown in this or other flowcharts related to this description, or some steps may be performed in parallel.

In a step S200 the working area 4 is defined. In a step S210a plurality of geographical data points 8 defining the working area 4 is stored in the database 2.

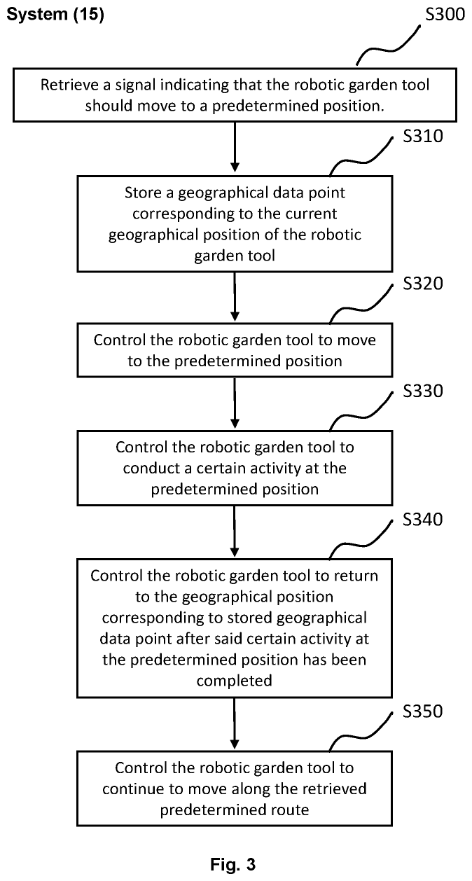

FIG. 3 shows a flow chart illustrating a procedure in a system. The various actions may come in different orders than presented in this description, or in a different order than shown in this or other flowcharts related to this description, or some steps may be performed in parallel.

In a step S300a signal 12 is retrieved by the control unit. The signal 12 indicates that the robotic garden tool 1 should move to a predetermined position 14. In a step S310a geographical data point 8 corresponding to the current geographical position of the robotic garden tool 1 is stored in the database 2. In a step S320 the robotic garden tool 1 is controlled by means of the control unit 13 to move to the predetermined position 14. In a step S330 the robotic garden tool 1 is controlled by means of the control unit 13 to conduct a certain activity at the predetermined position 14. In a step S340 the robotic garden tool 1 is controlled by means of the control unit 13 to return to the geographical position corresponding to stored geographical data point after said certain activity at the predetermined position 14 has been completed. In a step S350 the robotic garden tool 1 is controlled by means of the control unit 13 to continue to move along the retrieved predetermined route 3.

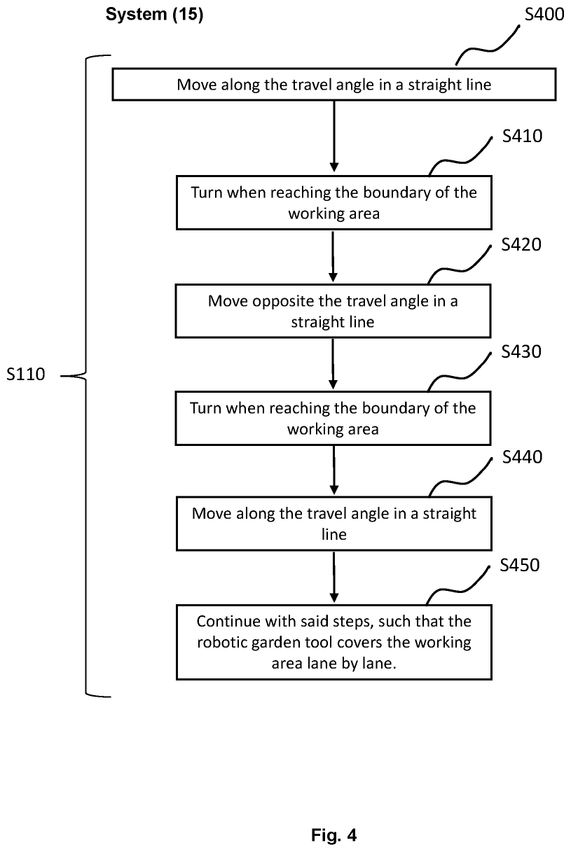

FIG. 4 shows a flow chart illustrating a procedure in a system. The various actions may come in different orders than presented in this description, or in a different order than shown in this or other flowcharts related to this description, or some steps may be performed in parallel.

In a step S400 the robotic garden tool 1 is controlled by means of the control unit 13 to move along the travel angle 5 in a straight line. In a step S410 the robotic garden tool 1 is controlled by means of the control unit 13 to turn when reaching the boundary 9 of the working area 4. In a step S420 the robotic garden tool 1 is controlled by means of the control unit 13 to move opposite the travel angle 5 in a straight line. In a step S430 the robotic garden tool 1 is controlled by means of the control unit 13 to turn when reaching the boundary 9 of the working area 4. In a step S440 the robotic garden tool 1 is controlled by means of the control unit 13 to move along the travel angle 5 in a straight line and continue with said steps such that the robotic garden tool 1 covers the working area 4 lane by lane.

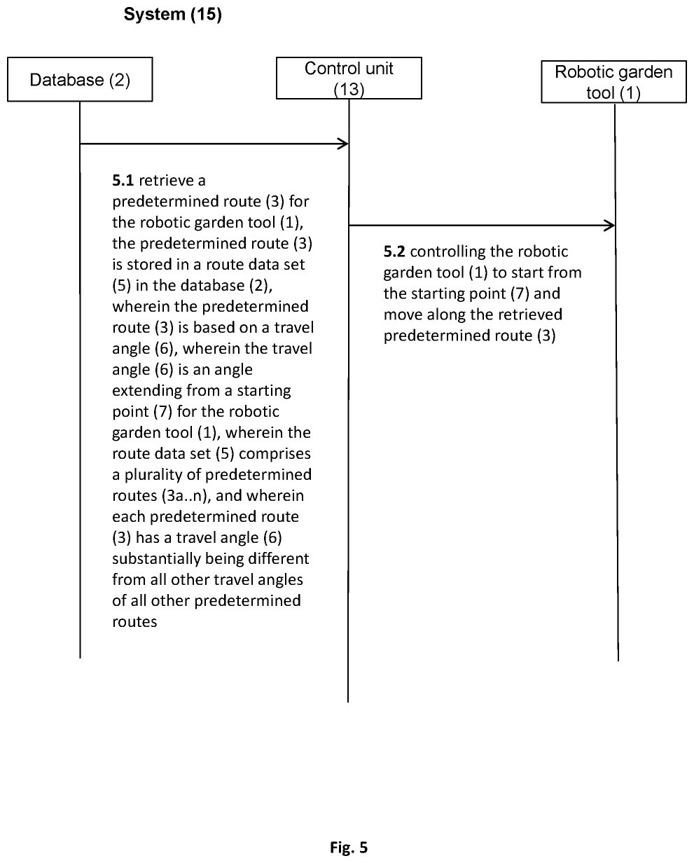

FIG. 5 shows a flow chart illustrating a procedure in a system. The various actions may come in different orders than presented in this description, or in a different order than shown in this or other flowcharts related to this description, or some steps may be performed in parallel.

In a step 1.1a predetermined route 3 for the robotic garden tool 1 is retrieved from the database 2 by means of the control unit 13. The predetermined route 3 is within a working area 4. The predetermined route 3 is stored in a route data set 5 in the database 2. The predetermined route 3 is based on a travel angle 6. The travel angle 6 is an angle extending from a starting point 7 for the robotic garden tool 1 located within the working area 4, and the working area 4 delimits the travel of the robotic garden tool 1. The route data set 5 comprises a plurality of predetermined routes 3a . . . n, and each predetermined route 3 has a travel angle 6 substantially being different from all other travel angles of all other predetermined routes. In a step 1.2 the robotic garden tool 1 is controlled by means of the control unit 13 to start from the starting point 7 and to move along the retrieved predetermined route 3.

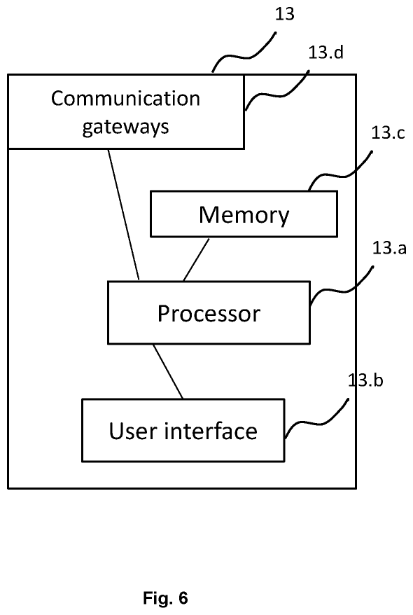

FIG. 6 shows a control unit 13, including components such as a processor 13.a, a user interface 13.b, a memory 13.c and communication gateways 13.d.

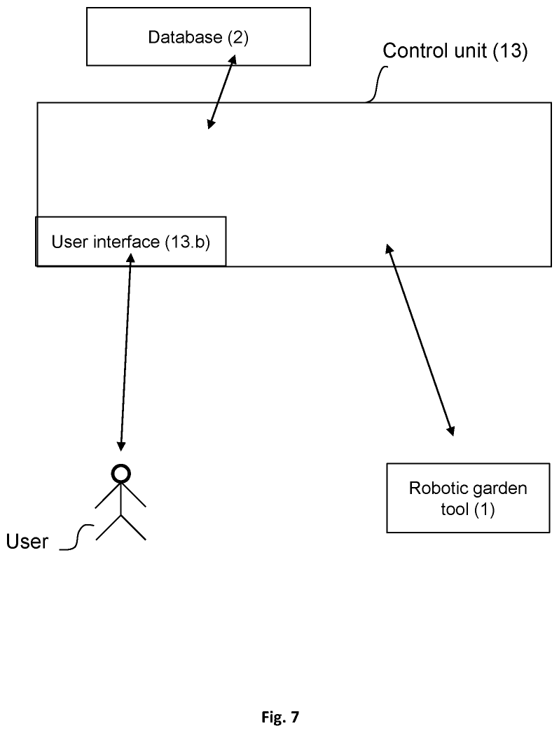

FIG. 7 shows a user interface 13.b of a control unit 13, a database 2, a robotic garden tool 1, and a user. The database 2, the robotic garden tool 1, and the user being connected to a control unit 13.

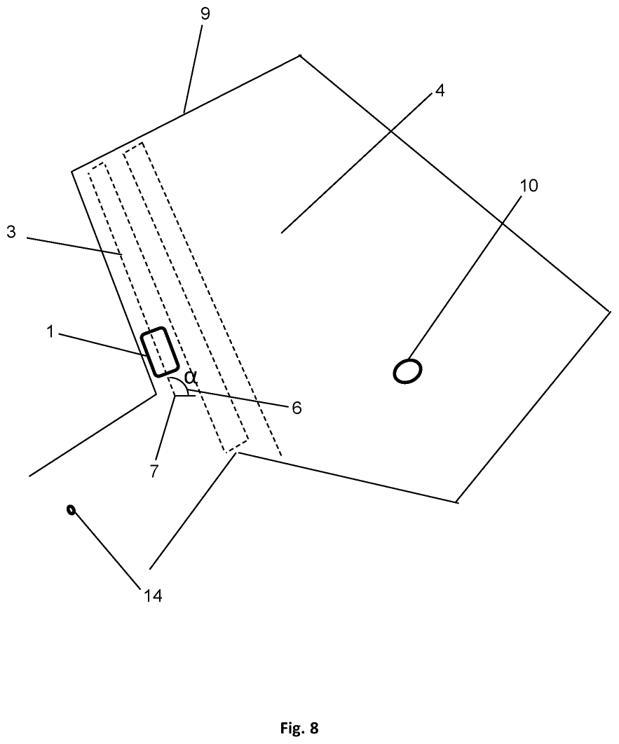

FIG. 8 shows a robotic garden system 15 and a robotic garden tool 1, in relation to a predetermined route 3, a working area 4, a travel angle 6, a starting point of the robotic garden tool 7, a boundary of the working area 9, an obstacle of the working area 10, and a predetermined position 14.

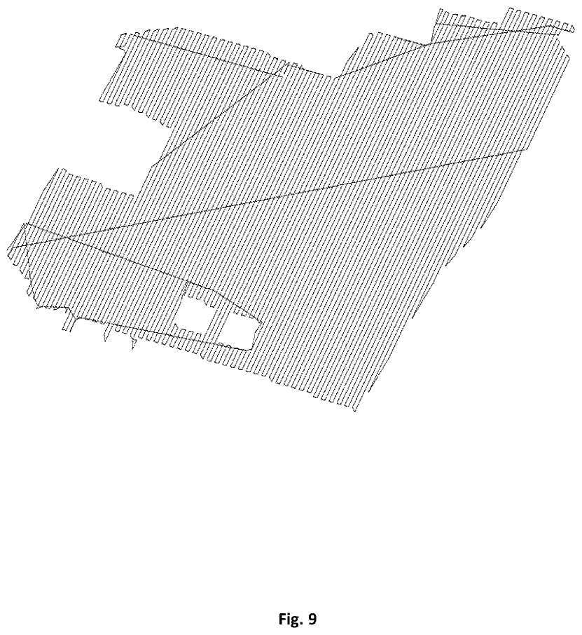

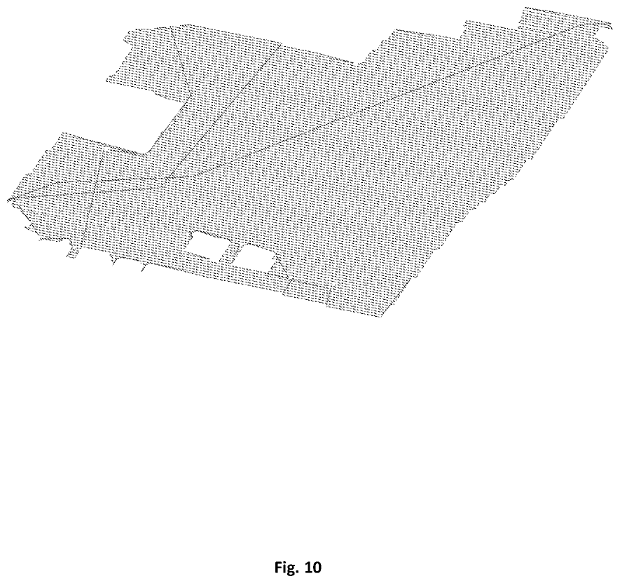

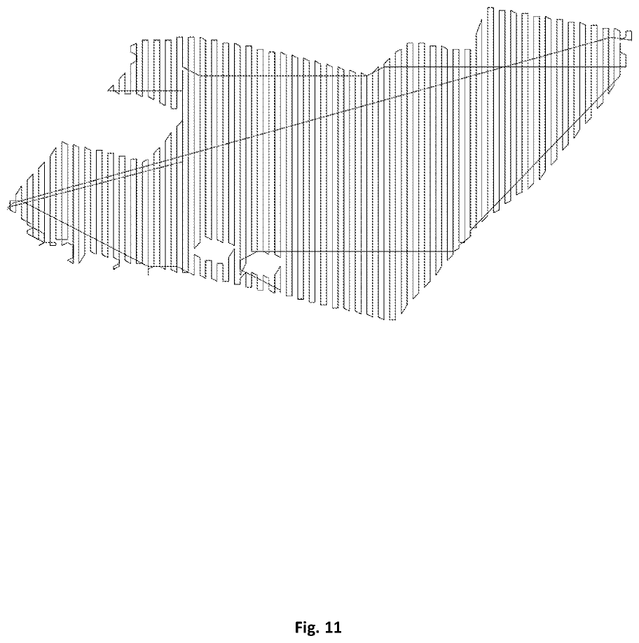

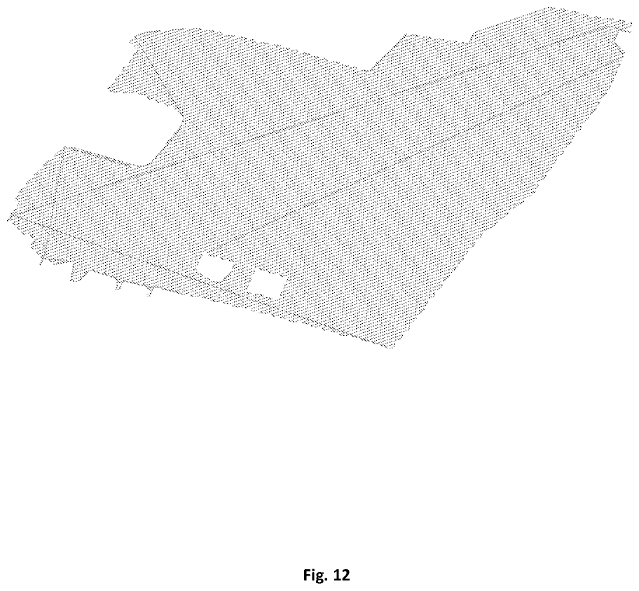

FIG. 9-12 show different types of predetermined routes based on different types of travel angels and different types of working widths of different robotic garden tools.

### LIST OF COMPONENTS

1=robotic garden tool
2=database
3=predetermined route
3a . . . n=a plurality of predetermined routes
4=working area
5=route data set
6=travel angle
7=starting point of the robotic garden tool
8=geographical data points
9=boundary of the working area
10=obstacle of the working area
11=positioning unit
12=a signal by a control unit
13=a control unit
14=predetermined position
15=robotic garden system

1. A method performed by a robotic garden system (15) for controlling a robotic garden tool (1), wherein the system (15) comprises the robotic garden tool (1), a control unit (13), and a database (2), wherein the method comprises the steps of:
A. retrieving, from the database (2) by means of the control unit (13), a predetermined route (3) for the robotic garden tool (1), wherein the predetermined route (3) is within a working area (4), wherein the predetermined route (3) is stored in a route data set (5) in the database (2), wherein the predetermined route (3) is based on a travel angle (6), wherein the travel angle (6) is an angle extending from a starting point (7) for the robotic garden tool (1) located within the working area (4), and wherein the working area (4) delimits the travel of the robotic garden tool (1), wherein the route data set (5) comprises a plurality of predetermined routes (3a . . . n), and wherein each predetermined route (3) has a travel angle (6) substantially being different from all other travel angles of all other predetermined routes,
B. controlling by means of the control unit (13) the robotic garden tool (1) to start from the starting point (7) and move along the retrieved predetermined route (3).

2. Method for controlling a robotic garden tool (1) according to claim 1, wherein the method is preceded by the steps of:
defining the working area (4), and
storing in the database (2) a plurality of geographical data points (8) defining the working area (4).

3. Method for controlling a robotic garden tool (1) according to claim 2, wherein the method further comprises the step of:
controlling the robotic garden tool (1) by means of the control unit (13) to follow the defined and stored working area (4) before conducting any further activities, such that the user can confirm that the stored working area (4) is correct.

4. Method for controlling a robotic garden tool (1) according to claim 2, wherein the defining of the working area comprises:
defining the boundary (9) of the working area (4).

5. Method for controlling a robotic garden tool (1) according to claim 4, wherein the defining of the boundary step comprises:
controlling the robotic garden tool (1) by means of the control unit (13) to follow the boundary (9) of the working area (4).

6. Method for controlling a robotic garden tool (1) according to claim 2, wherein the defining step of the working area comprises:
defining the boundary (9) of an obstacle (10) of the working area (4).

7. Method for controlling a robotic garden tool (1) according to claim 1, wherein in the retrieving step of a predetermined route, the predetermined route (3) is selected based on the criteria of minimising the number of turns of the robotic garden tool (1) within the working area (4).

8. Method for controlling a robotic garden tool (1) according to claim 1, wherein the travel angle (6) is in the range of 0 to 180° or in the range of 0 to 360°.

9. Method for controlling a robotic garden tool (1) according to claim 1, wherein a positioning unit (11) is in combination with the control unit used for controlling the robotic garden tool to follow the retrieved predetermined route (3), and/or the positioning unit (11) is used for providing a plurality of geographical data points (8) so that the working area (4) can be defined.

10. Method for controlling a robotic garden tool according to claim 1, wherein the method further comprises to:
A. retrieve a signal (12) by the control unit (13), wherein the signal (12) indicates that the robotic garden tool (1) should move to a predetermined position (14),
B. store in the database (2) a geographical data point (8) corresponding to the current geographical position of the robotic garden tool (1),
C. control the robotic garden tool (1) by means of the control unit (13) to move to the predetermined position (14),
D. control the robotic garden tool (1) by means of the control unit (13) to conduct a certain activity at the predetermined position (14),
E. control the robotic garden tool (1) by means of the control unit (13) to return to the geographical position corresponding to stored geographical data point after said certain activity at the predetermined position (14) has been completed, and
F. control the robotic garden tool (1) by means of the control unit (13) to continue to move along the retrieved predetermined route (3).

11. Method for controlling a robotic garden tool according to claim 4, wherein the controlling step of the robotic garden tool (1) to follow the retrieved predetermined route (3) comprises for the robotic garden tool (1) by means of the control unit (13) to:
A. move along the travel angle (5) in a straight line,
B. turn when reaching the boundary (9) of the working area (4),
C. move opposite the travel angle (5) in a straight line,
D. turn when reaching the boundary (9) of the working area (4),
E. move along the travel angle (5) in a straight line, and
F. continue with said steps,
such that the robotic garden tool (1) covers the working area (4) lane by lane.

12. A robotic garden system (15) for controlling a robotic garden tool (1), wherein the system (15) comprises the robotic garden tool (1), a control unit (13), and a database (2), wherein the system (15) is arranged to:
A. retrieve, from the database (2) by means of the control unit (13), a predetermined route (3) for the robotic garden tool (1), wherein the predetermined route (3) is within a working area (4), wherein the predetermined route (3) is stored in a route data set (5) in the database (2), wherein the predetermined route (3) is based on a travel angle (6), wherein the travel angle (6) is an angle extending from a starting point (7) for the robotic garden tool (1) located within the working area (4), and wherein the working area (4) delimits the travel of the robotic garden tool (1), wherein the route data set (5) comprises a plurality of predetermined routes (3a . . . n), and wherein each predetermined route (3) has a travel angle (6) substantially being different from all other travel angles of all other predetermined routes,
B. control by means of the control unit (13) the robotic garden tool (1) to start from the starting point (7) and move along the retrieved predetermined route (3).

13. A computer program, comprising computer readable code means, which when run on a control unit according to claim 12 causes the system (15) to perform a method by a robotic garden system (15) for controlling a robotic garden tool (1), wherein the system (15) comprises the robotic garden tool (1), the control unit (13), and a database (2), the method comprising:
A. retrieving, from the database (2) by means of the control unit (13), a predetermined route (3) for the robotic garden tool (1), wherein the predetermined route (3) is within a working area (4), wherein the predetermined route (3) is stored in a route data set (5) in the database (2), wherein the predetermined route (3) is based on a travel angle (6), wherein the travel angle (6) is an angle extending from a starting point (7) for the robotic garden tool (1) located within the working area (4), and wherein the working area (4) delimits the travel of the robotic garden tool (1), wherein the route data set (5) comprises a plurality of predetermined routes (3a . . . n), and wherein each predetermined route (3) has a travel angle (6) substantially being different from all other travel angles of all other predetermined routes,
B. controlling by means of the control unit (13) the robotic garden tool (1) to start from the starting point (7) and move along the retrieved predetermined route (3).

14. A computer program product, comprising a computer readable medium and a computer program according to claim 13, wherein the computer program is stored on the computer readable medium.
